(19) United States
(12) Patent Application Publication
(10) Pub. No.: US 2017/0121147 A1
(43) Pub. Date: May 4, 2017

(54) DESTINATION DISPATCH OVERLAY INCLUDING CAR POSITIONING MONITORING SYSTEM

(71) Applicant: OTIS ELEVATOR COMPANY, Farmington, CT (US)

(72) Inventors: Paul A. Stranieri, Bristol, CT (US); Daniel S. Williams, Southington, CT (US); Jason R. Armistead, Avon, CT (US)

(21) Appl. No.: 15/318,560

(22) PCT Filed: Jun. 15, 2015
(86) PCT No.: PCT/US2015/035772

§ 371 Date: Dec. 13, 2016

Related U.S. Application Data
(60) Provisional application No. 62/012,796, filed on Jun. 16, 2014.

(51) Int. Cl. B66B 1/24; B66B 5/00; B66B 1/46

(52) U.S. Cl. CPC B66B 1/2408; B66B 1/468; B66B 5/0018; B66B 2201/233; B66B 1/2458

(57) ABSTRACT

An elevator car dispatching system (100) comprises an elevator control module (102) that controls operation of at least one elevator car. A position monitoring mechanism (104) is coupled to a first elevator car among the at least one elevator car. The position monitoring mechanism (104) is configured to output a position signal in response to movement of the first elevator car. The elevator car dispatching system (100) further comprises an electronic dispatch module (106) that is in electrical communication with the elevator control module (102) and the position monitoring mechanism (104). The dispatch module (106) is configured to determine a vertical position of the first elevator car based on the position signal. The dispatch module (106) is further configured to output a dispatch command signal commanding the elevator control module (102) to adjust operation of the first elevator car based on the vertical position.

### TECHNICAL FIELD

The present invention relates generally to elevator systems, and more particularly, to elevator control systems.

### BACKGROUND

Elevator car dispatching systems determining a location of one or more elevator cars in a hoistway to facilitate destination dispatching. Conventional destination dispatching systems rely on a time-based location method which assumes a travel time needed for an elevator car to move between floors. Based on the assumed travel time, a location of a respective elevator car in the hoistway is estimated. If, however, the assumed travel time is different from the actual travel time, the location of the elevator car is estimated incorrectly.

### SUMMARY

According to an embodiment, an elevator car dispatching system comprises an elevator control module that controls operation of at least one elevator car. A position monitoring mechanism is coupled to a first elevator car among the at least one elevator car. The position monitoring mechanism is configured to output a position signal in response to movement of the first elevator car. The elevator car dispatching system further comprises an electronic dispatch module that is in electrical communication with the elevator control module and the position monitoring mechanism. The dispatch module is configured to determine a vertical position of the first elevator car based on the position signal. The dispatch module is further configured to output a dispatch command signal commanding the elevator control module to adjust operation of the first elevator car based on the vertical position.

In addition to one or more of the features described above or below, or as an alternative, further embodiments include:

a feature where the dispatch module determines a retarget position threshold corresponding to a newly called floor indicated by a newly received elevator car call, and determines whether to interrupt an ongoing dispatch of the respective elevator call based on a comparison between the vertical position indicated by the position signal and the retarget position threshold;

a feature where the dispatch module commands the elevator control module to stop the first elevator car at the newly called floor when the vertical position is outside the retarget position threshold;

a feature where the at least one elevator car includes a plurality of elevator cars, and wherein the dispatch module commands the elevator control module to control a second elevator car based on the vertical position of the first elevator car;

a feature where the dispatch module receives status information from the elevator control module, and wherein the dispatch command signal is based on the vertical position and the status information;

a feature where the status information includes at least one of car load status, brake status, car door status, car input power status, car calling status, service operation mode status, car weight status, and car emergency status, and microprocessor input power status.

a feature where the position monitor mechanism is an encoder.

a feature where the encoder is one of a rotary encoder, a liner encoder, or an optical digital encoder; and

a feature where the encoder is coupled to one of a car position transducer assembly, a machine assembly, a speed governor assembly, or a braking assembly.

According to an embodiment, a method of dispatching at least one elevator car included in an elevator system comprises outputting at least one control signal via an elevator control module to control a vertical position of the at least one elevator car. The method further includes outputting a position signal via a position monitoring mechanism coupled to a first elevator car among the at least one elevator car in response to moving the first elevator car. The method further includes a vertical position of the first elevator car based on the position signal. The method further includes outputting a dispatch command signal that commands the elevator control module to adjust operation of the first elevator car based on the vertical position.

In addition to one or more of the features described above or below, or as an alternative, further embodiments include:

a feature of determining a retarget position threshold corresponding to a newly called floor indicated by a newly received elevator car call, and determining whether to interrupt an ongoing dispatch of the respective elevator call based on a comparison between the vertical position indicated by the position signal and the retarget position threshold;

a feature of commanding the elevator control module to stop the first elevator car at the newly called floor when the vertical position is outside the retarget position threshold;

a feature where the at least one elevator car includes a plurality of elevator cars, and further comprising commanding the elevator control module to control a second elevator car based on the vertical position of the first elevator car;

a feature of generating the dispatch command signal based on the vertical position and additional status information received from the elevator control module;

a feature where the status information includes at least one of car load status, brake status, car door status, car input power status, car calling status, service operation mode status, car weight status, and car emergency status, and microprocessor input power status;

a feature of determining the vertical position using an encode; and

a feature where the encoder is one of a rotary encoder, a liner encoder, or an optical digital encoder, and wherein the encoder is coupled to one of a car position transducer assembly, a machine assembly, a speed governor assembly, or a braking assembly.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a block diagram of an elevator car dispatching system according to an embodiment;

FIG. 2 illustrates a dispatch module coupled to an elevator machine assembly included in an elevator car dispatching system according to an embodiment;

FIG. 3 illustrates a dispatch module coupled to a speed governor assembly included in an elevator car dispatching system according to an embodiment;

FIG. 4 illustrates a dispatch module coupled to a car position transducer assembly included in an elevator car dispatching system according to an embodiment;

FIGS. 5A-5B illustrates an elevator car dispatching system configured to control dispatching operation of an elevator car based on a measured vertical position and retarget position threshold according to an embodiment; and

FIG. 6 is a flow diagram illustrating a method of controlling an elevator car dispatching system based on a measured position of an elevator car according to an embodiment.

### DETAILED DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, an electronic processor (shared, dedicated, or group) and memory that executes one or more software or firmware programs, a combinational logic circuit, and/or other suitable components that provide the described functionality.

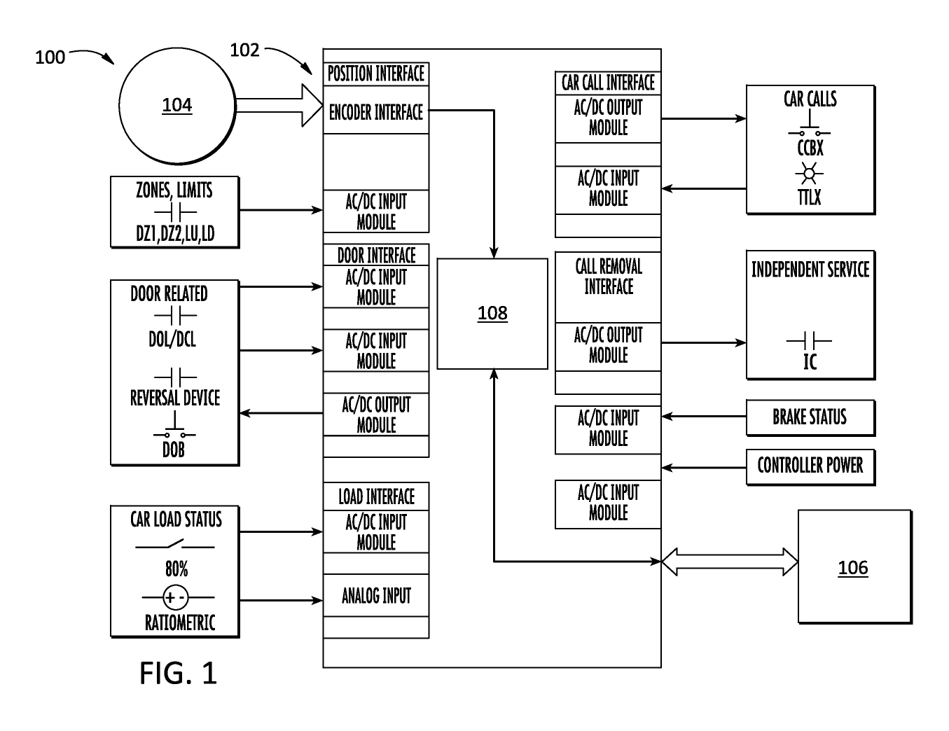

Referring now to FIG. 1, an elevator car dispatching system 100 is illustrated according to an embodiment. The elevator car dispatching system 100 includes an electronic main elevator control module 102, one or more positioning monitoring mechanisms 104, and an electronic dispatch module 106. The main elevator control module 102 includes a microcontroller 108 configured to provide an overlay interface and control operation of an elevator system. The microcontroller 108 may receive one or more input signals indicating status information corresponding to the elevator system. The status information includes, but is not limited to, car load status, brake status, car door status, car input power status, car calling status, service operation mode status, car weight status, and car emergency status, and microprocessor input power status. Based on the status information, the microprocessor 108 determines the status of the elevator system and/or the elevator cars included in the elevator system.

The position monitoring mechanism 104 is configured to determine a vertical position of a respective elevator car and output a position signal to the elevator control module 102. The position signal is indicative of a vertical position of the respective elevator car within an elevator hoist. Although a single positioning monitoring mechanism 104 is shown, it is appreciated that the elevator system may include a plurality of elevator cars and that each elevator car includes a respective position monitoring mechanism 104 coupled thereto. Accordingly, the elevator car dispatching system 100 may include a plurality of position monitoring mechanisms 104, each outputting a position signal indicating a vertical position of a respective elevator car.

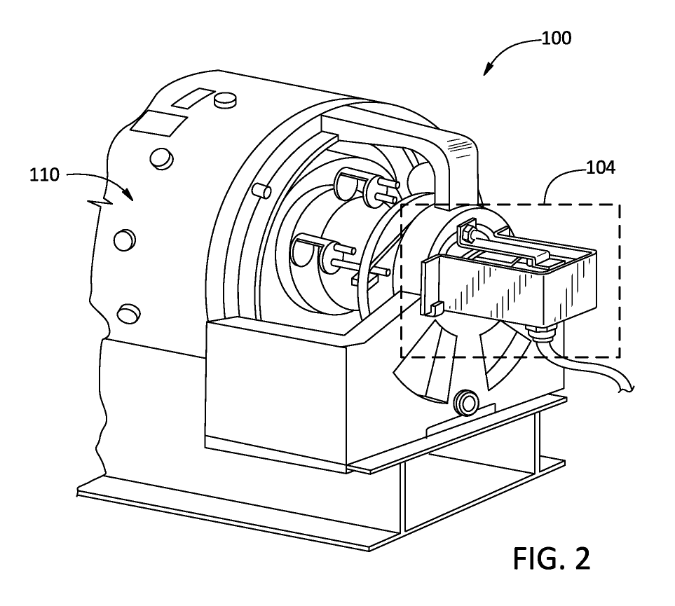

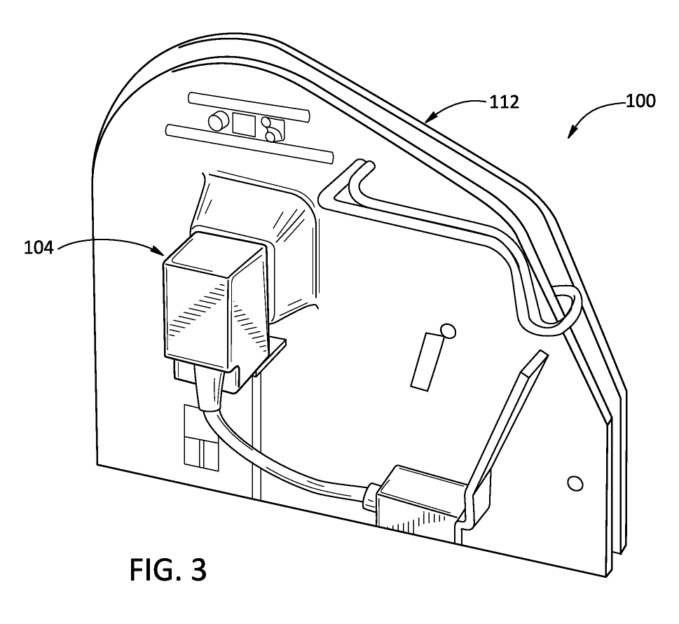

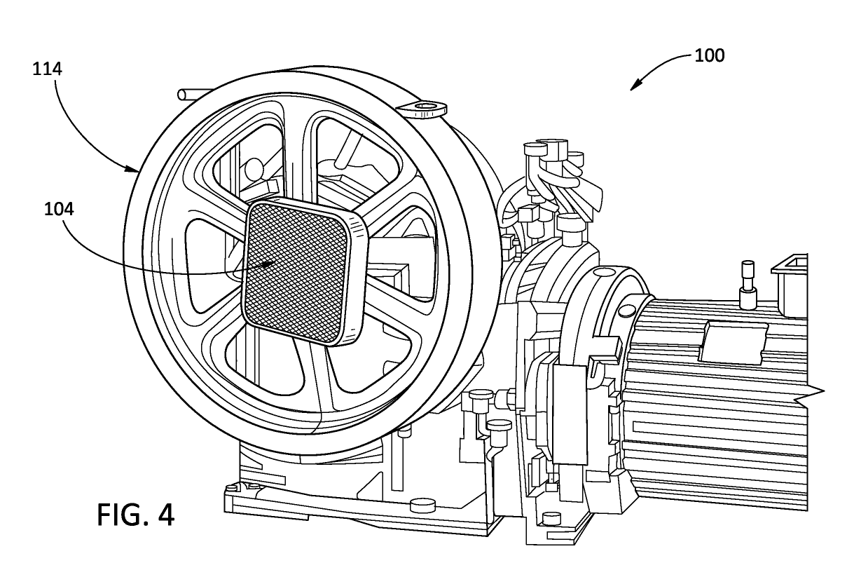

According to an embodiment, the position monitoring mechanism 104 is constructed as an encoder 104. Various types of encoders 104 may be used including, but not limited to, a rotary encoder, a liner encoder, and an optical digital encoder. The encoder 104 can be coupled to various portions or sub-assemblies of a respective elevator car. According to an embodiment, the encoder 104 is coupled to a machine assembly 110 of a respective elevator car controlled by the elevator car dispatching system 100 as illustrated in FIG. 2. According to another embodiment, the encoder 104 is coupled to a speed governor assembly 112 of a respective elevator car controlled by the elevator car dispatching system 100 as illustrated in FIG. 3. According to yet another embodiment, the encoder 104 is coupled to a car position transducer assembly 114 of a respective elevator car controlled by the elevator car dispatching system 100 as illustrated in FIG. 4. Slippage error that may affect the output of the encoder 104 may be reduced by arranging the encoder 104 on the car position transducer assembly 114.

The dispatch module 106 is in electrical communication with the elevator control module 102 and the position monitoring mechanisms 104. Although the dispatch module 106 is illustrated as being externally connected to the elevator control module 102 via a communication interface, it is appreciated that the dispatch module may be integrated within the elevator control module 102. The dispatch module 106 is configured to determine a vertical position of a respective elevator car based on the position signal output from the position monitoring mechanism 104. Based on the determined vertical position, the dispatch module 106 outputs a dispatch command signal that commands the elevator control module 102 to adjust operation of a respective elevator car. In this manner, one or more elevator cars are determined based on the actual measured position of a respective elevator car, as opposed to an assumed travel of time of an elevator car as performed by conventional elevator dispatching systems. Accordingly, the elevator car dispatching system 100 provides a more accurate elevator car location system when compared to conventional car dispatching systems using a time-based location method. Moreover, inaccurate determined elevator car locations caused by variations in speed of a respective elevator car are reduced.

Car dispatching systems are known to receive new car calls during an ongoing dispatch of an elevator car. For example, a new car call can be received by the elevator control module 102 when one or more passengers call for an elevator car to be dispatched to a newly requested floor during an ongoing elevator car dispatching operation. According to an embodiment, the dispatch module 106 is configured to determine a retarget position threshold corresponding to a newly called floor indicated by a newly received elevator car call. In this scenario, the dispatch module 106 determines whether to interrupt an ongoing dispatch of an elevator car based on a comparison between the vertical position indicated by the position signal and the retarget position threshold.

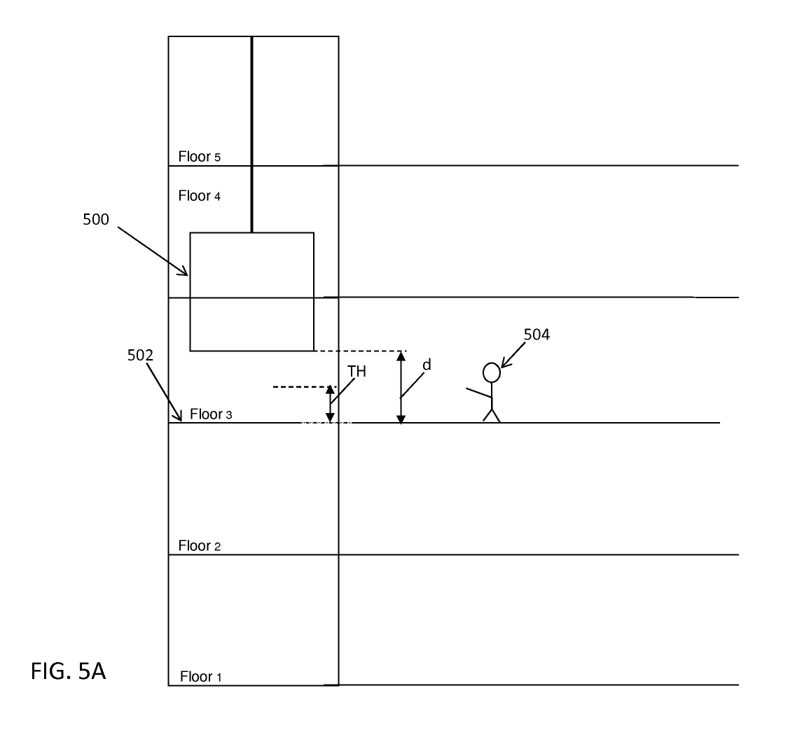

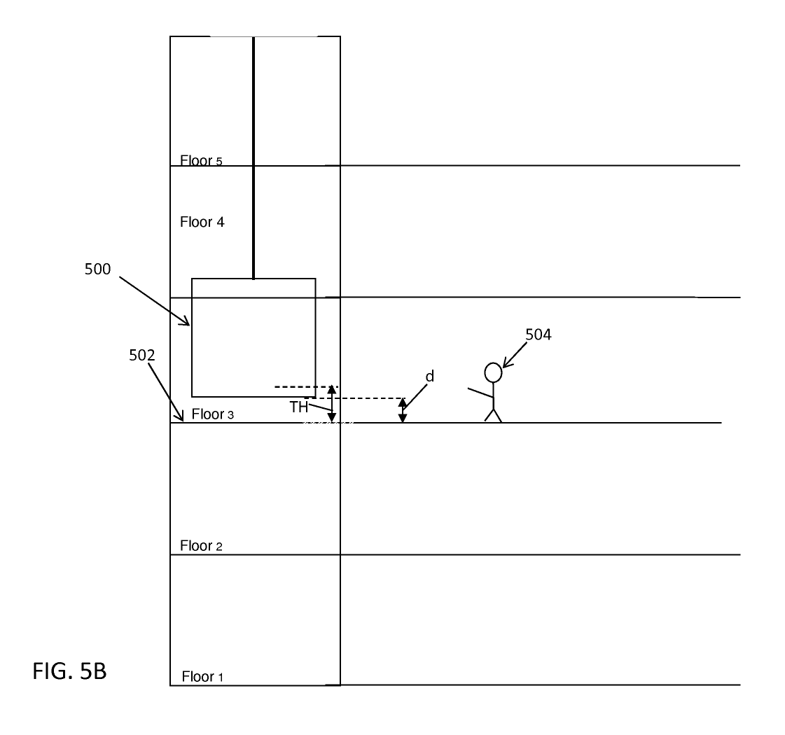

Turning to FIGS. 5A-5B, an example of operating an elevator car based on the retarget position threshold is illustrated. The vertical position measured by a position monitoring mechanism 104 described above can be used to determine a distance (d) between an elevator car 500 and a floor landing 502 of a newly called floor requested by a passenger 504. According to an embodiment, the distance (d) between an elevator car 500 and a floor landing 502 is compared to a retarget position threshold distance (TH). When the distance (d) is greater than the retarget position threshold distance (TH) as illustrated in FIG. 5A, the dispatch module 106 commands the elevator control module 102 to interrupt the ongoing dispatch operation and stop the elevator car 500 at the newly called floor 502. When, however, the distance (d) is less than the retarget position threshold (TH) (i.e., the distance falls within the retarget position threshold) as illustrated in FIG. 5B, the dispatch module 106 commands the elevator control module 102 to maintain the ongoing dispatch operation and move the elevator car 500 past the newly called floor 502. Accordingly, the performance of the elevator system can be improved.

According to an embodiment, the dispatch module 106 can control one or more elevator cars based on the position signal output from the 104 and additional status information. The status information can be communicated from the elevator control module 102 to the dispatch module 106 and/or can be received directly by the dispatch module 106. As described above, the status information may include, but is not limited to, car load status, brake status, car door status, car input power status, car calling status, service operation mode status, car weight status, and car emergency status, and microprocessor input power status.

In this scenario, a new elevator car call can be received that requests dispatch of an elevator car to a newly called floor. The dispatch module 106 may receive a position signal indicating that a first elevator car is currently located nearest to the newly called floor. Additional status information, however, may indicate that a load of the first elevator car is at full capacity or near full capacity, while a second elevator car having an empty load is located further away from the newly called floor. Since an empty elevator car is typically viewed by passengers as more convenient than a near loaded elevator car, for example, the dispatch module 106 may command the elevator control module 102 to interrupt dispatch of the first elevator call and command the elevator control module 102 to dispatch the second elevator car to the newly called floor. Accordingly, the performance of the elevator system can be improved.

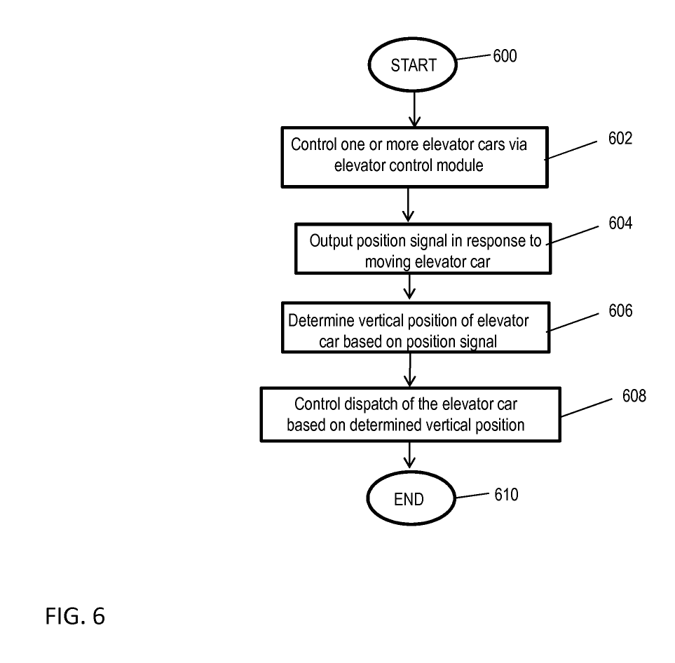

Referring now to FIG. 6, a flow diagram illustrates a method of controlling an elevator car dispatching system based on a measured position of an elevator car according to an embodiment. The method begins at operation 600, and at operation 602 one or more control signals are output via an elevator control module. The control signals control a vertical position of one or more elevator cars. At operation 604, a position signal is output via a position monitoring mechanism. The position signal may be automatically output in response to moving a respective elevator car. According to an embodiment, the position monitoring mechanism is coupled to a first elevator car among the at least one elevator car, and output the position signal in response to moving the first elevator car. The position monitoring mechanism may be constructed as an encoder which can be coupled to one of a car position transducer assembly, a machine assembly, a speed governor assembly, or a braking assembly. The encoder may include, but is not limited to, a rotary encoder, a liner encoder, and an optical digital encoder. At operation 606, a vertical position of the first elevator car is determined based on the position signal. At operation 608, dispatch operation of the first elevator car is controlled based on the vertical position, and the method ends at operation 610. According to an embodiment, an electronic dispatch module receives the position signal, determines the vertical position, and outputs a dispatch command signal that commands the elevator control module to operate the first elevator car based on the vertical position.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An elevator car dispatching system, comprising:
an elevator control module that controls operation of at least one elevator car;
a position monitoring mechanism coupled to a first elevator car among the at least one elevator car, the position monitoring mechanism configured to output a position signal in response to movement of the first elevator car; and
an electronic dispatch module in electrical communication with the elevator control module and the position monitoring mechanism, the dispatch module configured to determine a vertical position of the first elevator car based on the position signal, and to output a dispatch command signal commanding the elevator control module to adjust operation of the first elevator car based on the vertical position.

2. The car dispatching system of claim 1, wherein the dispatch module determines a retarget position threshold corresponding to a newly called floor indicated by a newly received elevator car call, and determines whether to interrupt an ongoing dispatch of the respective elevator call based on a comparison between the vertical position indicated by the position signal and the retarget position threshold.

3. The car dispatching system of claim 2, wherein the dispatch module commands the elevator control module to stop the first elevator car at the newly called floor when the vertical position is outside the retarget position threshold.

4. The car dispatching system of claim 3, wherein the at least one elevator car includes a plurality of elevator cars, and wherein the dispatch module commands the elevator control module to control a second elevator car based on the vertical position of the first elevator car.

5. The car dispatching system of claim 1, wherein the dispatch module receives status information from the elevator control module, and wherein the dispatch command signal is based on the vertical position and the status information.

6. The car dispatching system of claim 5, wherein the status information includes at least one of car load status, brake status, car door status, car input power status, car calling status, service operation mode status, car weight status, and car emergency status, and microprocessor input power status.

7. The car dispatching system of claim 6, wherein the position monitor mechanism is an encoder.

8. The car dispatching system of claim 7, wherein the encoder is one of a rotary encoder, a liner encoder, or an optical digital encoder.

9. The car dispatching system of claim 8, wherein the encoder is coupled to one of a car position transducer assembly, a machine assembly, a speed governor assembly, or a braking assembly.

10. A method of dispatching at least one elevator car included in an elevator system, the method comprising:
outputting at least one control signal via an elevator control module to control a vertical position of the at least one elevator car;
outputting a position signal via a position monitoring mechanism coupled to a first elevator car among the at least one elevator car in response to moving the first elevator car;
determining a vertical position of the first elevator car based on the position signal; and
outputting a dispatch command signal that commands the elevator control module to adjust operation of the first elevator car based on the vertical position.

11. The method of claim 10, further comprising determining a retarget position threshold corresponding to a newly called floor indicated by a newly received elevator car call, and determining whether to interrupt an ongoing dispatch of the respective elevator call based on a comparison between the vertical position indicated by the position signal and the retarget position threshold.

12. The method of claim 11, further comprising commanding the elevator control module to stop the first elevator car at the newly called floor when the vertical position is outside the retarget position threshold.

13. The method of claim 12, wherein the at least one elevator car includes a plurality of elevator cars, and further comprising commanding the elevator control module to control a second elevator car based on the vertical position of the first elevator car.

14. The method of any of claim 10, further comprising generating the dispatch command signal based on the vertical position and additional status information received from the elevator control module.

15. The method of claim 14, wherein the status information includes at least one of car load status, brake status, car door status, car input power status, car calling status, service operation mode status, car weight status, and car emergency status, and microprocessor input power status.

16. The method of claim 15, further comprising determining the vertical position using an encoder.

17. The method of claim 16, wherein the encoder is one of a rotary encoder, a liner encoder, or an optical digital encoder, and wherein the encoder is coupled to one of a car position transducer assembly, a machine assembly, a speed governor assembly, or a braking assembly.
